(19) United States
(12) Patent Application Publication
(10) Pub. No.: US 2024/0303542 A1
(43) Pub. Date: Sep. 12, 2024

(54) METHOD AND INFORMATION PROCESSING APPARATUS

(71) Applicant: TOYOTA JIDOSHA KABUSHIKI KAISHA, Toyota-shi (JP)

(72) Inventor: Shiro YANO, Nerima-ku (JP)

(73) Assignee: TOYOTA JIDOSHA KABUSHIKI KAISHA, Toyota-shi (JP)

(21) Appl. No.: 18/442,355

(22) Filed: Feb. 15, 2024

(30) Foreign Application Priority Data
Mar. 8, 2023 (JP) 2023-035702

(51) Int. Cl. G06N 20/00

(52) U.S. Cl. CPC G06N 20/00

(57) ABSTRACT

A first information processing apparatus transmits first information used for acquiring values of parameters of a machine learning model to a plurality of second information processing apparatuses. The plurality of the second information processing apparatuses acquire an evaluation value of the machine learning model when the value of the parameters acquired based on the first information is applied to the machine learning model, and transmit the evaluation value to the first information processing apparatus. The first information processing apparatus aggregates a plurality of evaluation values received from the plurality of the second information processing apparatuses, and transmits the aggregate result of the evaluation values to the plurality of the second information processing apparatuses. The first information processing apparatus and the plurality of the second information processing apparatuses update the machine learning model based on the aggregate result of the evaluation values.

### CROSS REFERENCE TO RELATED APPLICATION

This application claims the benefit of Japanese Patent Application No. 2023-035702, filed on Mar. 8, 2023, which is hereby incorporated by reference herein in its entirety.

### BACKGROUND

### Technical Field

The present disclosure relates to the learning of machine learning models.

### Description of the Related Art

Normally, when the machine learning model learns the learning data held by the plurality of devices, the learning data is collected in one place such as a server, for example, and the learning of the machine learning model is performed on the server. However, in this case, the confidentiality of the learning data is not protected. Federated learning is a learning method for machine learning models that protect the confidentiality of learning data. Federated learning is a method of having a machine learning model learn while distributed learning data is kept distributed.

In the Federated learning, the client has a machine learning model, and has the machine learning model learn using the holding learning data, and transmit the machine learning model after the learning to the server. The server merges the after learning machine learning model collected from each client and sends the merged machine learning model to the client again.

### CITATION LIST

### Patent Document

[Patent document 1] Japanese Patent Laid-Open No. 2022-136234

[Patent document 2] US Patent Application Publication No. 2020/0242514

### Non-Patent Document

[Non-Patent document 1] H. Brendan McMahan, 4 others, “Communication-Efficient Learning of Deep Networks from Decentralized Data,” Proceedings of Machine Learning Research Artificial intelligence and statistics, April 2017, Volume 54, p.1273-p.1282

[Non-Patent document 2] Tim Salimans, 4 others, “Evolution Strategies as a Scalable Alternative to Reinforcement Learning”, [online], September 2017, [Search on Nov. 4, 2022], Internet <URL: https://arxiv.org/abs/1703.03864>

[Non-Patent document 3] “A Visual Guide to Evolution Strategies”, [online], Oct. 29, 2017, [Search Nov. 14, 2022], Internet <URL: https://blog.otoro.net/2017/10/29/visual-evolution-strategies/>

However, in the Federated learning, since the machine learning model itself and/or the parameters of the machine learning model flow between the server and each client, the larger the size of the machine learning model, the larger the communication amount.

A subject of an aspect of the disclosure is to provide a method and an information processing apparatus capable of reducing the amount of data flowing between the information processing apparatuses when the learning of a machine learning model is performed by a plurality of information processing apparatuses.

### SUMMARY

An aspect of the present disclosure is a method including:
transmitting, by a first information processing apparatus, to a plurality of second information processing apparatuses, first information used to acquire values of parameters of a machine learning model;
acquiring, by the plurality of the second information processing apparatuses, an evaluation value of the machine learning model when a value of the parameters acquired based on the first information is applied to the machine learning model;
transmitting, by the plurality of the second information processing apparatuses, the evaluation value to the first information processing apparatus;
aggregating, by the first information processing apparatus, a plurality of evaluation values received from the plurality of the second information processing apparatuses;
transmitting, by the first information processing apparatus, an aggregate result of the plurality of the evaluation values to the plurality of the second information processing apparatuses;
updating, the first information processing apparatus and the plurality of the second information processing apparatuses, the machine learning model based on the aggregate result of the plurality of the evaluation values.

Another aspect of the present disclosure is an information processing apparatus including a processor configured to:
transmit, to a plurality of information processing apparatuses, first information used to acquire values of parameters of a machine learning model;
receive, from the plurality of the information processing apparatuses, an evaluation value of the machine learning model when the value of the parameters acquired based on the first information is applied to the machine learning model;
aggregate a plurality of evaluation values received from the plurality of the information processing devices;
transmitting an aggregate result of the plurality of the evaluation values to the plurality of the information processing devices; and
   updating the machine learning model based on the aggregate result of the plurality of the evaluation values.

Another aspect of the present disclosure is an information processing apparatus including a processor configured to:
receive, from a first information processing apparatus, first information used to acquire values of parameters of a machine learning model;
acquire an evaluation value of the machine learning model when a value of the parameters acquired based on the first information is applied to the machine learning model;
transmitting the evaluation value to the first information processing apparatus;
receiving, from the first information processing apparatus, an aggregate result of a plurality of evaluation values of the plurality of information processing apparatuses that have received the first information; and updating the machine learning model based on the aggregate result of the evaluation values.

According to an aspect of the present disclosure, when the learning of a machine learning model is performed by a plurality of information processing apparatuses, it is possible to reduce the amount of data flowing between the information processing apparatuses.

### BRIEF DESCRIPTION OF DRAWINGS

FIG. 1 is a diagram illustrating an example of a system configuration of Federated learning system 100 according to the first embodiment;

FIG. 2 is a diagram illustrating an example of the configuration of the server 1 and the client;

FIG. 3 is a diagram illustrating an example of a sequence of processing in the Federated learning system; and

FIG. 4 is a diagram illustrating an example of a system configuration of the Federated learning system 100B according to the second embodiment.

### DESCRIPTION OF THE EMBODIMENTS

One aspect of the present disclosure is a method in which learning of a machine learning model is performed by a first information processing apparatus and a plurality of second information processing apparatuses. The first information processing apparatus may be, for example, a server. The second information processing apparatus may be, for example, a terminal such as a personal computer (PC), a smartphone, a tablet terminal, an in-vehicle device, or the like. However, this is not limited to this. The first information processing apparatus may be a terminal, for example, similar to the second information processing apparatus. The in-vehicle device is, for example, a data communication device, a car navigation system, a drive recorder, and other electronic control units (ECUs).

The first information processing apparatus may transmit first information used for acquiring values of parameters of the machine learning model to the plurality of second information processing apparatus. The first information may be a string including predetermined number of characters such as, for example, a random number seed and a code associated with parameter. The plurality of second information processing apparatuses may acquire an evaluation value of the machine learning model when the value of the parameters acquired based on the first information is applied to the machine learning model, and transmit the evaluation value to the first information processing apparatus. For example, when the first information is a random number seed, the plurality of second information processing apparatuses may generate a random number from the received random number seed by a common random number generation method, and acquire the parameters of the machine learning model based on the random number. For example, when the first information is a code, the plurality of second information processing apparatuses may acquire the values of the parameters corresponding to the code received from a correspondence table including association the values of the code with the parameters held in advance.

The first information processing apparatus may aggregate a plurality of evaluation values of the machine learning model for the first information received from the plurality of second information processing apparatuses, and transmit an aggregate result to the plurality of second information processing apparatuses. The first information processing apparatus and the plurality of second information processing apparatuses may update the machine learning model based on the aggregate result of the evaluation values.

In one aspect of the present disclosure, the data flowing between the first information processing apparatus and the plurality of second information processing apparatuses may be the first information and an evaluation value and an aggregate value of the machine learning model for the first information. Each of the first information, the evaluation value, and the aggregate value may be a string including predetermined number of characters. Therefore, the size of the first information, the evaluation value, and the aggregate value may be about a few bytes, respectively. Therefore, according to one aspect of the present disclosure, when learning of a machine learning model is performed by a plurality of information processing apparatuses, it is possible to reduce the amount of communication data flowing between the information processing apparatuses.

The machine learning model included in the first information processing apparatus and the machine learning model included in each of the plurality of second information processing apparatuses may be the same model or different models. Further, the contents of the first information transmitted to each of the plurality of second information processing apparatuses may be the same or different between the plurality of second information processing apparatuses. Further, to each of the plurality of second information processing apparatuses, one piece of the first information may be transmitted or a plural piece of first information may be transmitted.

In the following, embodiments of the present disclosure will be described with reference to the drawings. The configuration of the embodiments described below are examples, and the present disclosure is not limited to the configuration of the embodiments.

### First Embodiment

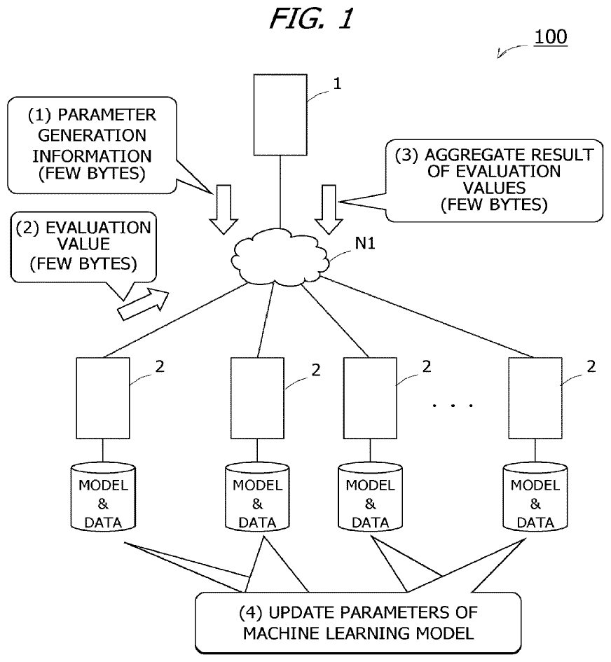

FIG. 1 is a diagram illustrating an example of a system configuration of Federated learning system 100 according to the first embodiment. The Federated learning system 100 is a system in which learning of machine learning model is performed in a state where learning data is distributed among a plurality of devices. The Federated learning system 100 includes a server 1 and a plurality of clients 2. The server 1 and the plurality of clients 2 is connected to the network N 1 and can communicate with each other through the network N 1. The network N 1 is, for example, a public network such as the Internet, a LAN (Local Area Network), a virtual or physical dedicated network, or the like.

In the first embodiment, it is assumed that the server 1 and the plurality of clients 2 have the same machine learning model. Further, it is assumed that values of parameters applied to the machine learning model are also shared with the server 1 and the plurality of clients 2. Therefore, when a new client 2 participates in the Federated learning system 100, the server 1 distributes the machine learning model and the values of the latest parameters to the new client 2. Hereinafter, when referred to as a parameter, it is intended to indicate the value of the parameter.

In the Federated learning system 100, the following processing is performed. (1) The server 1 transmits parameter generation information, which is information that is a species for generating parameters, to each client 2. The parameter generation information is, for example, a random number seed, a code associated with parameters or a variation value of the parameters, and the like. The parameter generation information is a predetermined number of character strings. Therefore, the size of the parameter generation information is, for example, about 1 byte to 100 bytes. The parameter generation information is an example of “first information”.

(2) Each client 2 acquires parameters based on the received parameter generation information, acquires an evaluation value of the machine learning model when the parameters are applied, and transmits the evaluation value to the server 1.

The evaluation value is a value representing the accuracy of the machine learning model when the parameters acquired based on the received parameter generation information are applied to the machine learning model. For example, in the case of supervised learning, the evaluation value may be a degree of similarity indicating how close the output value of the machine learning model is to the correct value. For example, in the case of reinforcement learning, the evaluation value may be a value indicating how much the output value of the machine learning model satisfies the required criteria. Hereinafter, the evaluation value of the machine learning model in the case where the parameters acquired based on the parameter generation information are applied to the machine learning model is simply referred to as the evaluation value for the parameter generation information. Since the evaluation value is a string of a predetermined number of numbers, its size is about a few bytes. It is noted that the evaluation value of the machine learning model may also be said to be a value representing the performance of the machine learning model. The performance of the machine learning model includes, for example, “accuracy” such as how close the output value of the machine learning model is to the correct value, or how much the output value of the machine learning model meets the required criteria, and furthermore, also includes how much operating costs such as human and expense are incurred.

(3) The server 1 aggregates the evaluation values received from each client 2 for the parameter generation information, and transmits the aggregate result to each client 2. (4) The server 1 and each client 2 update the machine learning model held by itself based on the aggregate result of the evaluation values. In the first embodiment, updating the machine learning model is updating values of parameters of the machine learning model. In the first embodiment, in (4), when the aggregate result of the evaluation values is better than the evaluation value of the currently applied parameter, the server 1 and each client 2 update the machine learning model by applying the parameters acquired based on the parameter generation information transmitted from the server 1 in (1).

In the Federated learning system 100, the learning of the machine learning model is performed by performing the processing of (1) to (4) on a predetermined number of random number seeds, or by repeatedly performing the processing of (1) to (4) until the aggregate value of the evaluation values satisfies predetermined condition. The server 1 is an example of the “first information processing apparatus”. The client 2 is an example of a “second information processing apparatus”.

Each client 2 holds different evaluation data. Therefore, as in the first embodiment, even if each client 2 uses the same value parameters as the same machine learning model, the evaluation value is different for each client 2. However, by updating the values of the parameters of the machine learning model to the values of the parameters that the aggregate result of the evaluation values of each client 2 is better, the machine learning model becomes more accurate when viewed as the client 2 as a whole. A machine learning model with the similar level of accuracy as the learning of a normal machine learning model will be acquired.

In the Federated learning system 100, the data flowing between the server 1 and each client 2 is parameter generation information, an evaluation value, and aggregate result of evaluation values, whose sizes are about a few bytes. Therefore, according to the first embodiment, when learning of the machine learning model is performed while learning data is distributed to a plurality of devices, the amount of communication data can be reduced. In the following description, it is assumed that in the Federated learning system 100, a random number seed is adopted as the parameter generation information.

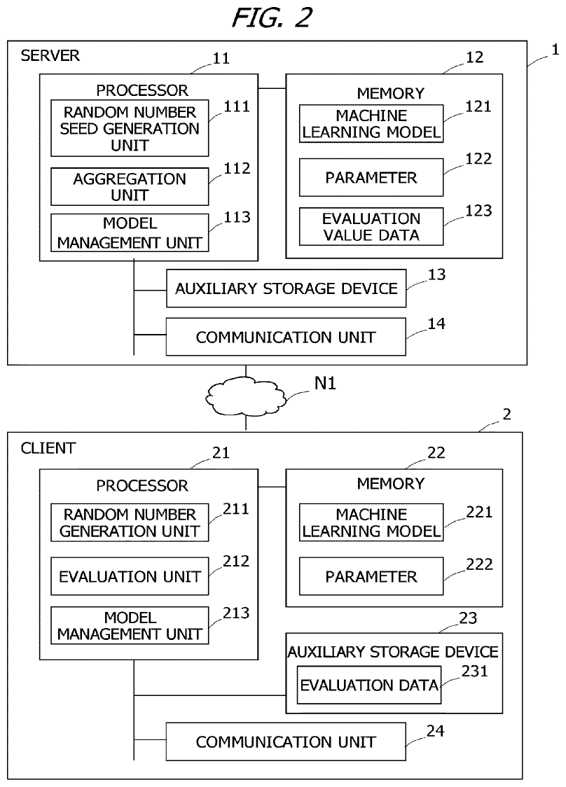

FIG. 2 is a diagram illustrating an example of the configuration of the server 1 and the client 2. The server 1 is, for example, a computer dedicated to the Federated learning system 100. However, the server 1 is not limited thereto. The server 1 includes, for example, a processor 11, a memory 12, an auxiliary storage device 13, and a communication unit 14.

The auxiliary storage device 13 stores, for example, an OS (Operation System), a plurality of other programs, and data used by the processor 11 when executing each program. The auxiliary storage device 13 is, for example, a hard disk drive (HDD) and a solid state drive (SSD). The memory 12 is a memory that provides the processor 11 with a storage area and an operation area for loading a program stored in the auxiliary storage device 13, or is used as a buffer. The memory 12 includes, for example, a semiconductor memory such as a ROM (Read Only Memory) and a RAM (Random Access Memory).

The processor 11 loads a program held in the auxiliary storage device 13 into the memory 12 and executes various processes. The processor 11 is not limited to one, and may include a plurality of processors 11. The processor 11 is an example of a “processor”.

The communication unit 14 is a module, for example, such as a LAN (Local Area Network) card and an optical module, that connects a network cable and includes a signal processing circuit. The communication unit 14 is not limited to a circuit that is able to be connected to a wired network, and may be a wireless signal processing circuit that is able to process wireless signals of a wireless communication network such as WiFi.

When the processor 11 executes a predetermined program held in the auxiliary storage device 13, the processing of the functional configuration of a random number seed generation unit 111, an aggregation unit 112, and a model management unit 113 is achieved. The random number seed generation unit 111 transmits seeds of pseudo-random numbers to each client 2. A random seed is a string of a predetermined number of numbers that are primes of a pseudo-random number. The random seed to be transmitted may be determined at random, or may be transmitted in order of decreasing value.

The aggregation unit 112 receives the evaluation values for the random number seed from each client 2 and performs aggregation. The evaluation value for the random seed may also be said to be an evaluation value representing the performance of the machine learning model when the parameters acquired based on the random seed are applied to the machine learning model. The aggregation method of the evaluation values may be, for example, any of the methods for obtaining the total value, the average value, the median value, the standard deviation value, and the like of the evaluation values from each client 2. The aggregation method of the evaluation values from each client 2 is not limited to a predetermined method. The aggregation unit 112 transmits the aggregate value of the evaluation values to each client 2.

The model management unit 113 updates the machine learning model 121 based on, for example, the aggregate value of the evaluation values acquired by the aggregation unit 112. For example, when the aggregate value of the evaluation values acquired by the aggregation unit 112 is better than the aggregate value of the evaluation value for the random number seed corresponding to the values of the parameter 122 currently applied to the machine learning model 121, the model management unit 113 updates the machine learning model 121 by applying parameters using pseudo-random numbers acquired from the random number seed corresponding to the aggregate value of the evaluation values acquired by the aggregation unit 112.

The memory 12 holds the machine learning model 121, the parameter 122, and the evaluation value data 123. The machine learning model 121 may be any of, for example, a neural network, a deep learning model, a convolutional neural network, a recursive neural network, or the like. The machine learning model 121 is not limited to a model according to a specific algorithm. The parameter 122 is values of a parameter currently applied to the machine learning model 121. In the first embodiment, the evaluation value data 123 is, for example, the evaluation values of each client 2 for each random seed and the aggregate value.

Next, the client 2 is, for example, a PC, a smartphone, a tablet terminal, and an in-vehicle device. The in-vehicle device is, for example, a data communication device, a car navigation system, a drive recorder, an ECU dedicated to the Federated learning system 100, and the like. The client 2 includes, for example, a processor 21, a memory 22, an auxiliary storage device 23, and a communication unit 24 as hardware configurations.

The processor 21, the memory 22, the auxiliary storage device 23, and the communication unit 24 are the similar as the processor 11, the memory 12, the auxiliary storage device 13, and the communication unit 14, respectively. However, the communication unit 24 may be a circuit that is able to be connected to a wired network and a wireless network. When the communication unit 24 is a circuit that is able to be connected to a wireless network, the communication unit 24 may be a mobile communication method such as 5G, 4G, 3G, or 6G, a wireless communication method such as Wi-Fi, or a wireless communication circuit corresponding to DSRC (Dedicated Short Range Communications). In FIG. 2, the hardware configuration of the client 2 is illustrated by extracting only the elements related to the processing of the Federated learning system 100.

When the processor 21 executes a predetermined program held in the auxiliary storage device 23, the processing of the functional configuration of a random number generation unit 211, an evaluation unit 212, and a model management unit 213 is achieved. The random number generator 211 receives a random number seed from the server 1 and generates a pseudo-random number from the random number seed. The generated pseudo-random number has the same dimension as the machine learning model 221 described later. It is noted that there may be a usage in which pseudo-random numbers are generated and used in the same number as the dimension (number) of the input value (or explanatory variable) of the machine learning model 221. Pseudo-random number generation algorithms are not limited to specific ones. Further, in the first embodiment, it is assumed that the same pseudo random number generation algorithm is used in the server 1 and the plurality of clients 2.

The evaluation unit 212 calculates an evaluation value for a random number seed received from the server 1 and transmits the evaluation value to the server 1. When the index of client 2 is expressed as i=1 to M, the evaluation data held by the i-th client 2 is Di. When all clients 2 use the same random number seed, let εt be the random number generated from the random number seed received at the t-th time (t is a positive integer). εt is a value independent of index i. For the evaluation data Di, the objective function for evaluating the machine learning model 221 when the parameter x is applied is denoted by f (x, Di).

The parameter currently applied to the machine learning model 221 is denoted by xt. The parameter acquired by the evaluation unit 212 based on the random number εt is denoted by xt+εt. Xt+εt stands for that the parameter xt currently applied to the machine learning model 221 is moved by the random number εt to acquire the parameter xt+εt. However, the method of acquiring the parameter based on the random number εt is not limited to a specific method. However, in the first embodiment, it is assumed that the server 1 and each client 2 have the same method of acquiring a parameter based on the random number εt.

The evaluation unit 212 acquires y (t, i)=f (xt+εt, Di) as an evaluation value for the parameter xt+εt acquired from the random number seed received from the server 1.

For example, when the machine learning model 221 is a supervised or unsupervised learning model, the objective function f (x, Di) is a function acquiring the output value of the machine learning model 221 with respect to the input value for the evaluation data Di and the degree of similarity or the accuracy rate between the correct value and the evaluation data Di. For example, when the machine learning model 221 is a reinforcement learning model, the objective function f (x, Di) is a function acquiring a value that indicates how much the output value of the machine learning model 221 with respect to the input for the evaluation data Di satisfies the criteria.

When there are a plurality of evaluation data, the evaluation unit 212 obtains an evaluation value for each evaluation data, and transmits the aggregate values of the plurality of evaluation values to the server 1. The method for aggregating the evaluation values of the plurality of evaluation data may be, for example, a method for obtaining any of the average value, the median value, the standard deviation value, or the like, and is not limited to a specific method.

The model management unit 213 manages the machine learning model 221. When the model management unit 213 receives the aggregate value of the evaluation values for the random number seed from the server 1, and updates the machine learning model 221 based on the aggregate value of the evaluation values. The updating method of the machine learning model 221 by the model management unit 213 is the same as that of the model management unit 113.

The memory 22 holds a machine learning model 221 and a parameter 222. The machine learning model 221 is the same model as the machine learning model 121 in the first embodiment. The same machine learning model indicates that the values of the algorithms, dimensions, and parameters used are the same in this specification. The parameter 222 is values of parameters currently applied to the machine learning model 221.

The evaluation data 231 is stored in the auxiliary storage device 23. The evaluation data 231 is data acquired by the client 2 by a predetermined sensor. The evaluation data 231 includes, for example, image data, operation data, air temperature data, speed data, and the like. The evaluation data corresponds to the learning data in the learning of the normal machine learning model.

The hardware configuration and the functional configuration of the server 1 and the client 2 illustrated in FIG. 2 are examples, and the server 1 and the client 2 are not limited to the configuration illustrated in FIG. 2 For example, when the client 2 is a smartphone, the client 2 includes a touch panel display, a microphone, a speaker, a GPS (Global Positioning System) receiver, a camera, and various other sensors.

### Processing Flow

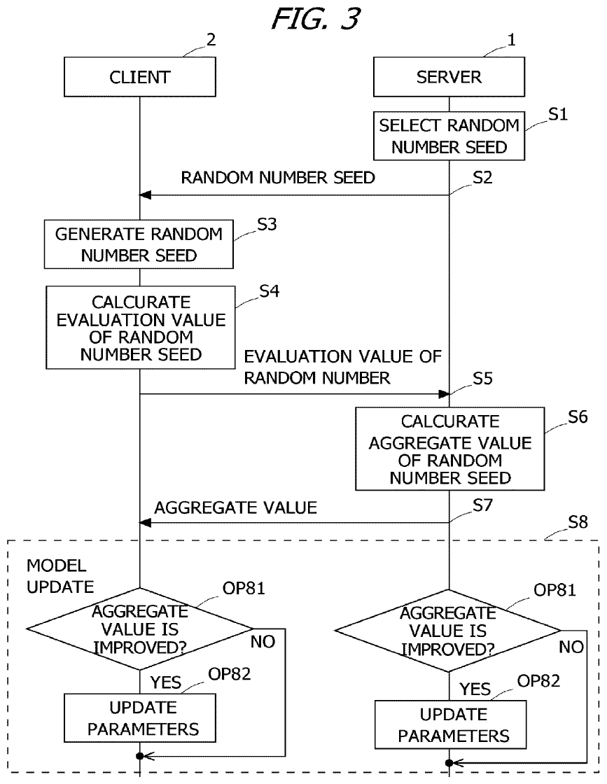

FIG. 3 is a diagram illustrating an example of a sequence of processing in the Federated learning system 100. In FIG. 3, for the sake of simplification of the description, only the server 1 and one client 2 are illustrated. However, the other client 2 performs the similar operation.

In S1, the random number seed generation unit 111 of the server 1 acquires the random number seed. In S2, the random number seed generation unit 111 of the server 1 transmits the random number seed to each client 2. In S3, the random number generation unit 211 of the client 2 generates a pseudo-random number from the random number seed received from the server 1. In S4, the evaluation unit 212 of the client 2 acquires the values of the parameter using the pseudo-random number generated from the random number seed received from the server 1, and calculates the evaluation value for the machine learning model 221 when the values of the parameter is applied. In S5, the evaluation unit 212 of the client 2 transmits the evaluation value for the random number seed to the server 1.

Therefore, the server 1 receives the evaluation values of each client 2 for the random number seed transmitted in S2 from each client 2.

In S6, the aggregation unit 112 of the server 1 aggregates the evaluation values of each client 2 for the random number seed transmitted in S2. In S7, the aggregation unit 112 of the server 1 transmits the aggregate value of the evaluation values of each client 2 for the random number seed transmitted in S2 to each client 2.

In S8, the model management unit 113 of the server 1 and the model management unit 213 of each client 2 perform a model update process. In the first embodiment, since the model update processing is common to the model management unit 113 of the server 1 and the model management unit 213 of each client 2, the processing of the model management unit 213 of the client 2 will be described as an example. In OP81, the model management unit 213 determines whether or not the aggregate value of the evaluation values received from the server 1 is improved, compared to the aggregate value of the evaluation value for the random number seed corresponding to the values of the parameter currently applied to the machine learning model. The evaluation value for the random number seed corresponding to the values of the parameter currently applied to the machine learning model 221 may be held by the client 2 or may be transmitted to each client 2 by the server 1 in S7. If it is indicated that the higher the evaluation value of the random number seed, the higher the evaluation value of the machine learning model when the random number seed is used, and if the aggregate value of the evaluation values received from the server 1 is also increased, it is indicated that the aggregate value of the evaluation values received from the server 1 is improved. If it is indicated that the smaller the evaluation value of the random number seed, the higher the evaluation of the machine learning model when using the random number seed, and if the aggregate value of the evaluation values received from the server 1 is also decreased, it is indicated that the aggregate value of the evaluation values received from the server 1 is improved.

When the aggregate value of the evaluation values received from the server 1 is improved (OP 81: YES), the process proceeds to OP 82. In OP82, the model management unit 213 of the client 2 updates the machine learning model 221 by applying a parameter acquired based on the random number seed received from the server 1 in S2. Further, the model management unit 213 overwrites and stores the parameter 222 with the parameter acquired based on the random number seed received from the server 1 in S2. When the aggregate value of the evaluation values received from the server 1 has not been improved (OP 81: NO), the model management unit 213 does not update the machine learning model 221. The model update process of S8 illustrated in FIG. 3 is an example, and the model update process is not limited to the process illustrated in FIG. 3

Learning of the machine learning model at one time in the Federated learning system 100 ends, for example, by executing the process illustrated in FIG. 3 for a predetermined number of random number seeds, or when the aggregate value of the evaluation value for the random number seeds is equal to or greater than less than a predetermined threshold value. Furthermore, at the next learning, each client 2 uses different evaluation data. Furthermore, at the next learning, a different set of random seed seeds may be used.

### Operations and Effects of the First Embodiment

In the first embodiment, when the learning of the machine learning model is performed by distributed by the plurality of devices, for example, the data flowing between the server 1 and each client 2 is the random number seed, evaluation values for the random number seed, and the aggregate value of the evaluation values. All of these data are about a few bytes in size. In conventional Federated learning, the machine learning model itself or the parameters of the machine learning model flow between the server and the client. These sizes are in megabytes or gigabytes. Therefore, according to the Federated learning system 100 according to the first embodiment, when the learning of the machine learning model is performed by distributed among the plurality of devices, the amount of communication data flowing between the server 1 and each client 2 and the communication load related to the server 1 and each client 2 can be reduced. Therefore result, for example, even if there is a gap in the communication speed between the clients 2 due to the presence of some clients 2 in an area where only a low communication speed can be secured, it is possible to shorten the time related to the learning of the machine learning model in the Federated learning system 100 without being affected. Therefore, it will also allow machine learning models to learn data from areas where communication is difficult, such as disaster areas and digital divides. Further, since processing such as compression is not performed on the transmission data (random number seed, evaluation value for random number seed, and aggregate value of evaluation values), processing load by data transmission can be suppressed in the server 1 and each client 2.

In the first embodiment, it is difficult to restore the evaluation data held by each client 2 from the random number seed, the evaluation values for the random number seed, and the aggregate values of the evaluation values, flowing between the server 1 and each client 2. Therefore, according to the Federated learning system 100 according to the first embodiment, the protection of privacy can be further strengthened.

### Second Embodiment

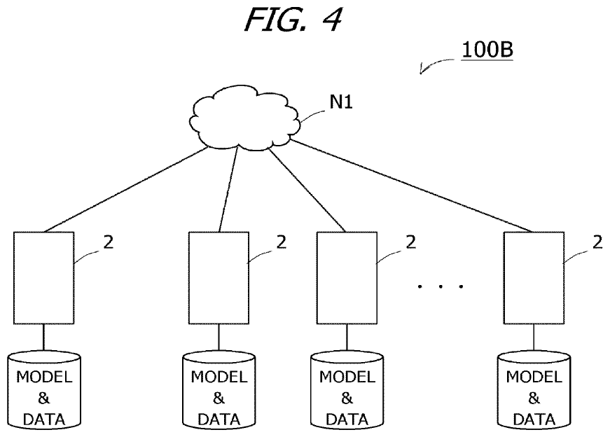

The Federated learning system according to the second embodiment is a system configured of the client 2 without including a server. FIG. 4 is a diagram illustrating an example of a system configuration of the Federated learning system 100B according to the second embodiment. The Federated learning system 100B includes a plurality of clients 2. In the Federated learning system 100B, one of the plurality of clients 2 executes processing such as generation of random number seeds and aggregation of evaluation values in the similar manner as the server 1 according to the first embodiment. Note that the client 2 playing the role of the server 1 may change each time learning is performed. The selection method of the client 2 that plays the role of the server 1 is not limited to a specific method. For example, information such as communication throughput and processor performance may be exchanged between the clients 2, and the client 2 having the best performance may be selected as the client 2 playing the role of the server 1. In the second embodiment, the client 2 that plays the role of the server 1 is an example of the “first information processing apparatus”.

### Other Embodiments

The embodiments described above are examples, and the present disclosure may be changed and carried out as appropriate without departing from the gist of the present disclosure.

In the first embodiment, it is described on the premise that there is one random seed transmitted from the server 1 to each client 2. It is not limited thereto, and there may be a plurality of random number seeds transmitted from the server 1 to each client 2. In this case, each client 2 acquires evaluation values for each of a plurality of random number seeds received from the server 1 and transmits the evaluation values to the server 1. The server 1 acquires the aggregate value of the evaluation values from each client 2 for each of the plurality of random number seeds. The server 1 transmits to each client 2 the random number seed, which is the best aggregate value of the evaluation values among the plurality of random number seeds, and the aggregate value of the evaluation values of the random number seed. For example, the server 1 and each client 2 may perform a model update process (see S8 in FIG. 3) in the similar manner as in the first embodiment using the aggregate value of the best evaluation value among the plurality of random number seeds.

In the first embodiment, it is described on the premise that a random number seed is transmitted from the server 1 to each client 2. It is not limited thereto, and supplementary information may be transmitted from the server 1 to each client 2 in addition to the random number seed. The supplementary information is information that specifies a pseudo-random number used to acquire the parameter. For example, the supplementary information is information that specifies that the generation of pseudo-random numbers is started from the random number seed to be transmitted together, and that the acquired pseudo-random numbers are used after repeating 100 times. Even if the parameter generation information is information other than the random number seed, the parameter generation information and the supplementary information may be transmitted from the server 1 to each client 2. The supplementary information is also text data, and its size is about a few bytes.

In the first embodiment, it is described on the premise that the server 1 and the plurality of clients 2 include the same machine learning model and the same parameters. It is not limited to this, the server 1 and the plurality of clients 2 may include different machine learning models. In this case, even if the server 1 and the plurality of clients 2 use the same random number seed, they generate pseudo-random numbers with different dimensions according to the machine learning model included each. Further, the algorithm for generating pseudo-random numbers may be different for each of the server 1 and the plurality of clients 2.

In the first embodiment, the server 1 is described on the premise of transmitting the same random number seed to a plurality of clients 2. Not limited thereto, the server 1 may transmit a different random seed for each client 2. For example, when the process illustrated in FIG. 3 is executed once, for each of the plurality of random number seeds transmitted to each client 2, each time the evaluation value is received from each client 2, the server 1 may aggregate it together with the evaluation values collected from each client 2 up to that point, and may transmit the random number seed having the best aggregate value at that time and the aggregate value of it to each client 2. The server 1 and each client 2 update the machine learning model based on the random number seed having the best aggregate value at that time and the aggregate value.

Furthermore, by combining those, the server 1 and the plurality of clients 2 have different machine learning models, and the server 1 may transmit different random seed for each client 2.

The processes and means described in the present disclosure may be freely combined to the extent that no technical conflict exists.

A process which is described to be performed by one device may be performed among a plurality of devices. Processes described to be performed by different devices may be performed by one device. Each function to be implemented by a hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. A method comprising:
transmitting, by a first information processing apparatus, to a plurality of second information processing apparatuses, first information used to acquire values of parameters of a machine learning model;
acquiring, by the plurality of the second information processing apparatuses, an evaluation value of the machine learning model when a value of the parameters acquired based on the first information is applied to the machine learning model;
transmitting, by the plurality of the second information processing apparatuses, the evaluation value to the first information processing apparatus;
aggregating, by the first information processing apparatus, a plurality of evaluation values received from the plurality of the second information processing apparatuses;
transmitting, by the first information processing apparatus, an aggregate result of the plurality of the evaluation values to the plurality of the second information processing apparatuses;
updating, the first information processing apparatus and the plurality of the second information processing apparatuses, the machine learning model based on the aggregate result of the plurality of the evaluation values.

2. The method according to claim 1, wherein
the first information is a string including a predetermined number of characters.

3. The method according to claim 1, wherein
the first information processing apparatus and the plurality of the second information processing apparatus set parameters acquired based on the first information in which the aggregate result of the evaluation value is the best among the plurality of first information to update the machine learning model.

4. An information processing apparatus comprising a processor configured to:
transmit, to a plurality of information processing apparatuses, first information used to acquire values of parameters of a machine learning model;
receive, from the plurality of the information processing apparatuses, an evaluation value of the machine learning model when the value of the parameters acquired based on the first information is applied to the machine learning model;
aggregate a plurality of evaluation values received from the plurality of the information processing devices;
transmitting an aggregate result of the plurality of the evaluation values to the plurality of the information processing devices; and
updating the machine learning model based on the aggregate result of the plurality of the evaluation values.

5. An information processing apparatus comprising a processor configured to:
receive, from a first information processing apparatus, first information used to acquire values of parameters of a machine learning model;
acquire an evaluation value of the machine learning model when a value of the parameters acquired based on the first information is applied to the machine learning model;
transmitting the evaluation value to the first information processing apparatus;
receiving, from the first information processing apparatus, an aggregate result of a plurality of evaluation values of the plurality of information processing apparatuses that have received the first information; and
updating the machine learning model based on the aggregate result of the evaluation values.
